(19) United States
(12) Patent Application Publication
(10) Pub. No.: US 2026/0081260 A1
(43) Pub. Date: Mar. 19, 2026

(54) BATTERY PACK THERMAL BARRIERS WITH OVERLAPPING INTERFACES

(71) Applicant: Ford Global Technologies, LLC, Dearborn, MI (US)

(72) Inventors: Bhaskara Rao Boddakayala, Troy, MI (US); Di Zhu, Novi, MI (US)

(21) Appl. No.: 18/888,891

(22) Filed: Sep. 18, 2024

(51) Int. Cl. H01M 10/658; B60L 50/64; H01M 50/211; H01M 50/293; H01M 50/358

(52) U.S. Cl. CPC H01M 10/658; B60L 50/64; H01M 50/211; H01M 50/293; H01M 50/358; H01M 2220/20

(57) ABSTRACT

A traction battery pack assembly includes first and second thermal barriers, each comprising a divider section and a covering section. The assembly further comprises one or more battery cells positioned between the divider sections of the first and second thermal barriers along a cell stack axis. The covering section of the first thermal barrier extends over a portion of the battery cells and interfaces with the covering section of the second thermal barrier. Additionally, the covering sections of the first and second thermal barriers are axially overlapped along the cell stack axis.

### TECHNICAL FIELD

This disclosure relates generally to thermal barriers of a battery pack and, more particularly, to how the thermal barriers interface with each other within the battery pack.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack assembly, including: first and second thermal barriers each having a divider section and a covering section; and one or more battery cells sandwiched between the divider section of the first thermal barrier and the divider section of the second thermal barrier along a cell stack axis, the covering section of the first thermal barrier extending axially over at least a portion of the one or more battery cells and interfacing with the covering section of the second thermal barrier, the covering section of the first thermal barrier at least partially axially overlapped with the covering section of the second thermal barrier along the cell stack axis.

In some aspects, the techniques described herein relate to a traction battery pack assembly, wherein the covering section of the first thermal barrier overlaps with the second thermal barrier through a shiplap interface.

In some aspects, the techniques described herein relate to a traction battery pack assembly, wherein the covering section of the first thermal barrier overlaps with the second thermal barrier through a tongue and groove interface.

In some aspects, the techniques described herein relate to a traction battery pack assembly, wherein the covering section of the first thermal barrier includes a lip that extends beneath the covering section of the second thermal barrier.

In some aspects, the techniques described herein relate to a traction battery pack assembly, wherein the covering section of the first thermal barrier includes a plurality of first covering section teeth that extend into respective recesses provided by the covering section of the second thermal barrier, wherein the covering section of the second thermal barrier includes a plurality of second covering section teeth that extend into respective recesses provided by the covering section of the first thermal barrier.

In some aspects, the techniques described herein relate to a traction battery pack assembly, wherein the plurality of first covering section teeth are vertically aligned with the plurality of second covering section teeth.

In some aspects, the techniques described herein relate to a traction battery pack assembly, wherein the covering section of the first thermal barrier includes a lip that extends beneath the covering section of the second thermal barrier.

In some aspects, the techniques described herein relate to a traction battery pack assembly, wherein the lip includes a mica material.

In some aspects, the techniques described herein relate to a traction battery pack assembly, wherein the mica material is insert molded.

In some aspects, the techniques described herein relate to a traction battery pack assembly, wherein the first thermal barrier and the second thermal barrier each have a T-shaped cross-sectional profile.

In some aspects, the techniques described herein relate to a traction battery pack assembly, further including a mesh material at least partially embedded within the covering section of the first thermal barrier.

In some aspects, the techniques described herein relate to a traction battery pack assembly, further including adhesively bonding the first thermal barrier to an enclosure of a traction battery pack with an adhesive contacting the mesh material.

In some aspects, the techniques described herein relate to a traction battery pack assembly, wherein the first thermal barrier is a multi-layered, polymer-based structure.

In some aspects, the techniques described herein relate to a traction battery pack assembly, wherein an interface between the covering section of the first thermal barrier and the second thermal barrier is a non-linear interface.

In some aspects, the techniques described herein relate to a traction battery pack assembly, wherein a gap between the covering section of the first thermal barrier and the covering section of the second thermal barrier is configured to communicate vent byproducts.

In some aspects, the techniques described herein relate to a traction battery pack assembly, including: first and second thermal barriers each having a T-shaped cross-section with a stem section and a T-top section; and one or more battery cells sandwiched between the stem section of the first thermal battery and the stem section of the second thermal barrier along a cell stack axis, the T-top section of the first thermal barrier extending axially over at least a portion of the one or more battery cells in a first axial direction, the T-top section of the second thermal barrier extending axially over at least a portion of the one or more battery cells in a second axial direction and interfacing with the T-top section of the first thermal barrier along a non-linear interface.

In some aspects, the techniques described herein relate to a traction battery assembly, wherein the non-linear interface is vertically non-linear and horizontally non-linear.

In some aspects, the techniques described herein relate to a traction battery assembly, wherein the T-top section of the first thermal barrier horizontally overlaps the T-top section of the second thermal barrier, wherein the T-top section of the first thermal barrier vertically overlaps the T-top section of the second thermal barrier.

In some aspects, the techniques described herein relate to a traction battery assembly, wherein a gap at the non-linear interface is configured to communicate vent byproducts emitted from the one or more battery cells.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a perspective view of a battery pack from the electrified vehicle of FIG. 1.

FIG. 3 illustrates a perspective view of a cell stack from the battery pack of FIG. 2.

FIG. 4 illustrates a section view taken at line 4-4 in FIG. 2.

FIG. 5 is a close-up view of an area of FIG. 3.

FIG. 6 is a close-up view of an area of FIG. 4.

FIG. 7 is a perspective view of a thermal barrier from the cell stack of FIG. 3.

### DETAILED DESCRIPTION

This disclosure details exemplary traction battery packs having thermal barriers that interface within each other along non-linear interfaces. Battery cells of the battery pack can periodically discharge vent byproducts, which can move between the thermal barriers. Due to the non-linear interfaces, the vent byproducts move along a tortuous path when flowing between thermal barriers. This can help to distribute thermal energy associated with the vent byproducts.

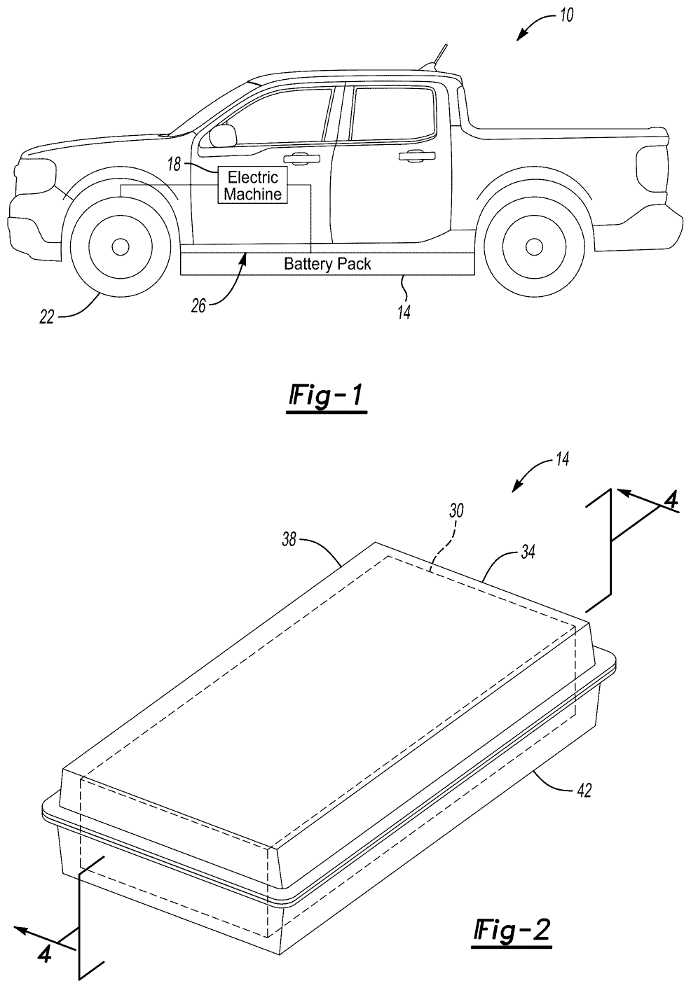

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

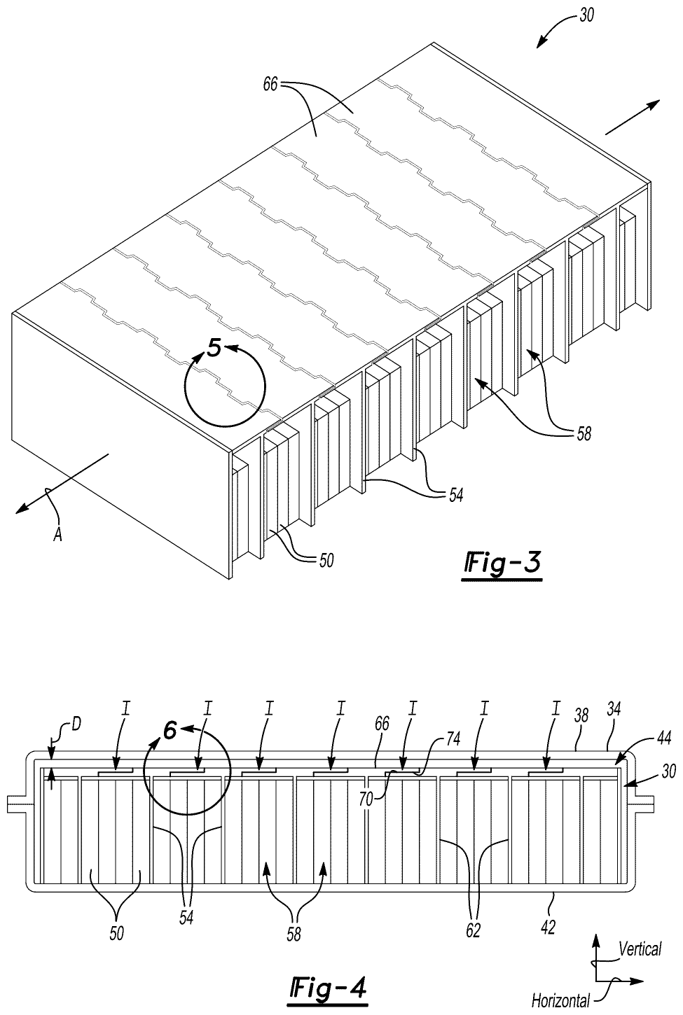

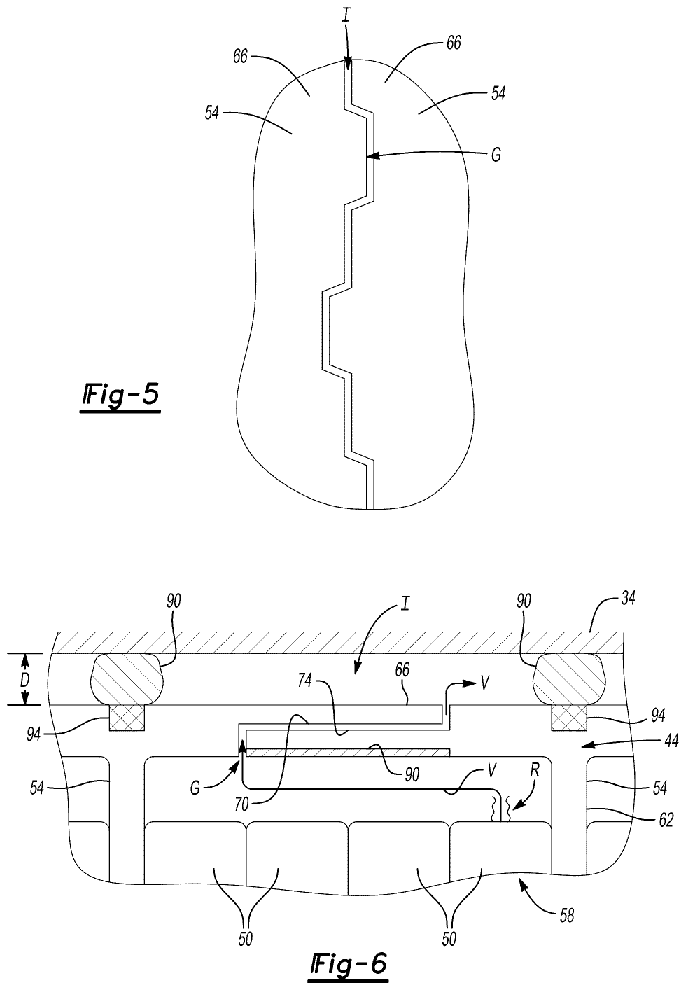

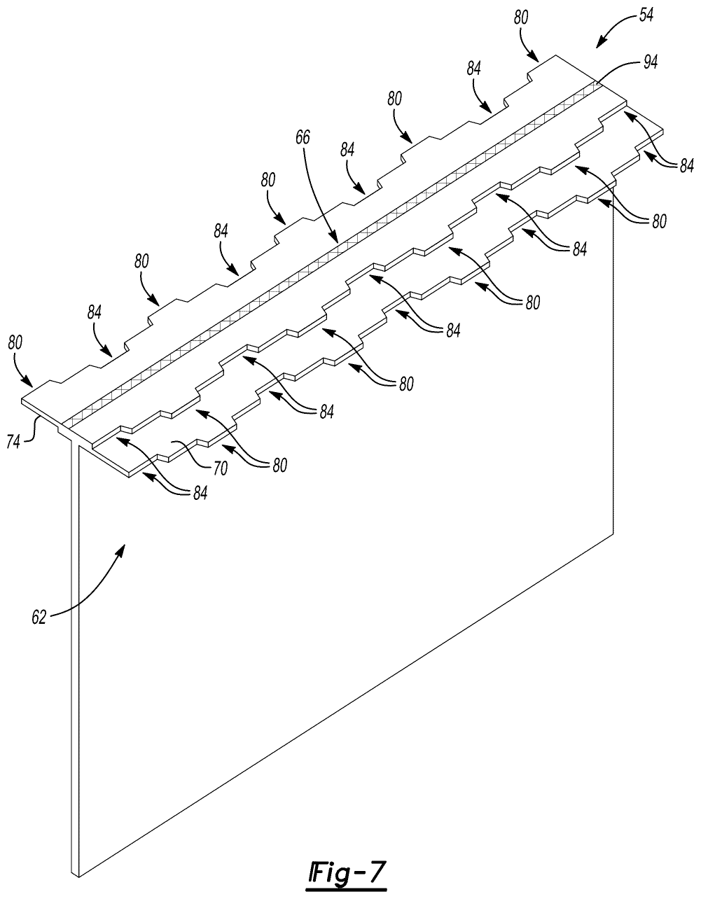

With reference now to FIG. 2-7 the battery pack 14 includes a plurality of cell stacks 30 held within an enclosure assembly 34. In the exemplary embodiment, the enclosure assembly 34 includes an enclosure cover 38 and an enclosure tray 42. The enclosure cover 38 can be secured to the enclosure tray 42 to provide an interior area 44 that houses the cell stacks 30. The enclosure cover 38 can be secured to the enclosure tray 42 using mechanical fasteners (not shown), for example.

Each of the cell stacks 30 includes, among other things, a plurality of battery cells 50 (or simply “cells”) and one or more thermal barriers 54 disposed along a respective cell stack axis A. The battery cells 50 store and supply electrical power. Although a specific number of the cell stacks 30 and cells 50 are illustrated in the various figures of this disclosure, the battery pack 14 could include any number of the cell stacks 30 each having any number of individual cells 50.

In an embodiment, the battery cells 50 are lithium-ion pouch-style cells. However, battery cells having other geometries (cylindrical, prismatic, etc.), other chemistries (nickel metal hydride, lead acid, etc.), or both could be alternatively utilized within the scope of this disclosure.

With the cell stacks 30, the individual battery cells 50 can be electrically connected together. The cell stacks 30 can also be connected to each other. To facilitate these electrical connections, the battery cells 50 each include a pair of tab extending outward from a case. The tab terminals are typically thin strips of foil. The tab terminals can be, for example, copper foil or aluminum foil.

The battery cells 50 are arranged in groups 58, which are separated from each other along the axis A by the thermal barriers 54. In this example, the battery pack 14 includes seven groups 58 of four battery cells 50, and two groups 58 of two battery cells 50.

The thermal barriers 54 each have a divider section 62 and a covering section 66. In this example, the dividers sections 62 and the covering sections 66 project outward from the cell stack axis past the groups 58 of battery cells 50. In some examples, other dividers without covering sections can be disposed between the individual battery cells 50. The dividers without covering sections could be multi-layered structures including a mica layer sandwiched between foam layers.

The divider sections 62 are vertically aligned and are the portions of the thermal barriers 54 that are between the battery cells 50 along the cell stack axis A. The groups 58 of four battery cells 50 are each sandwiched between the divider sections 62 of two thermal barriers 54. Vertical and horizontal, for purposes of this disclosure are with reference to ground and a general orientation of the battery pack 14 when installed with the vehicle 10.

The covering sections 66 extend horizontally from a vertical upper portion of the divider sections 62, which gives the thermal barriers 54 a T-shaped cross-sectional profile. The covering sections 66 can be considered to provide a T-top section of the T-shape and the divider sections 62 a stem section of the T-shape.

The covering sections 66 are spaced vertically a distance D from the battery cells 50. The covering sections 66 can extend horizontally toward the covering section 66 of an axially adjacent thermal barrier 54. The covering sections 66 of axially adjacent thermal barriers 54 meet at interfaces I. For each of the interfaces I, there are gaps G between the covering sections 66 in at least some areas. Due to, among other things, tolerances, the axially adjacent covering sections 66 may contact each other in some areas while spaced apart in other areas to provide the gaps G.

The thermal barriers 54 can help to compartmentalize the interior area 44. If, for example, one of the battery cells 50 undergoes a thermal event and begins to discharge vent byproducts V (FIG. 6), the vent byproducts V can be discharged vertically upward through a ruptured area R of the battery cell 50 or through a defined vent. The thermal barriers 52 block those vent byproducts V from moving axially adjacent to another groups 58 of battery cells 50. Movement of the vent byproducts V along the cell stack axis A toward other battery cells 50 that are not venting can increase thermal energy levels in those battery cells 50 and can lead to those battery cells 50 venting. The vent byproducts V are instead directed through the interface I between axially adjacent covering sections 66 to an area that is between the covering sections 66 and an underside of the enclosure cover 38. The gaps G are configured to communicate the vent byproducts V through the interface I.

Again, the thermal barriers 52 can block vent byproducts V from moving along the cell stack axis near another group 58 of battery cells 50. The thermal barriers 52—and in particular the covering sections 66—of block vent by products that have moved through the interface between covering sections 66 from moving vertically downward toward another groups 58 of battery cells 50.

At each interface I, the covering section 66 of one thermal barrier 52 overlaps with the covering section 66 of the the thermal barrier 52. That is, the covering section 66 of a first one of the thermal barriers 52 extends axially in a first direction over one of the groups 58, and the covering section 66 of a second of the thermal barriers 52 extends axially in an opposite, section direction to at least partially axially overlap with a portion of the covering section 66 of the first one of the thermal barriers 52. In this example, the axial overlap comprises both an vertical overlap and a horizontal overlap. In other examples, only a vertical overlap or only a horizontal overlap could be implemented.

In particular, in this example, one thermal barrier 52 includes a lower lip 70 that extends vertically beneath an upper lip 74 of the axially adjacent thermal barrier 52. This interface I can be considered a shiplap interfaces. In another example, the interface I can be a tongue and groove interface where the covering section 66 of one of the thermal barriers 52 fits within a groove provide by the covering section 66 of another of the thermal barriers 52. The overlap provided by the shiplap interface and the tongue and groove interface are vertical overlaps. Due to the vertical overlap, the interface I is a non-linear interface. In an example, for a given one of the thermal barriers 52, the covering section 66 can extend about twenty-five millimeters from the divider section 62 in both axial directions. The lower lip 70 and the upper lip 74 can both be about ten to fifteen millimeters.

Each of the covering sections 66 includes a plurality of covering section teeth 80 that project horizontally. Areas between teeth 80 are recesses 84. When installed with the battery pack, the covering section teeth 80 extend into respective recesses 84 provided by the covering section 66 of the axially adjacent thermal barrier 52. This overlap provided by the teeth being received within the recesses are horizontal overlaps. The covering section teeth 80 and the recess 84 are at the same vertical height. Due to the horizontal overlaps, the interface I is a non-linear interface.

During a thermal event where one or more of the battery cells 50 is venting, the vertical overlap and the horizontal overlap can present a tortuous path for the vent byproducts to move through the interface I to the area that is between the covering sections 66 and the underside of the enclosure cover 38. The tortuous path can slow movement of the vent byproducts to this area giving the vent byproducts potentially time to cool. The horizontal overlap, in particular, can help to ensure that the vent byproducts emitted from the battery cells 50 contact an underside of two of the thermal barriers 52, which can help to distribute thermal energy between the two thermal barriers 52.

In this example, the undersides of the lower lips 70 can include a mica material 88 that is insert molded. The mica material 88 can help the lower lip withstand the vent byproducts V. The remaining portions of the thermal barriers 52 can be a polymer-based material that is injection molded. In some examples, the thermal barriers 52, and particularly the divider sections 62 can be multi-layered structures having, for example, one or more sheets of mica, one or more sheets of intumescent endothermic aerogel, one or more polymer-based layer, such as a pultruded layer, etc. The intumescent endothermic aerogel sheet can be activated when exposed to thermal energy associated with vent byproducts V. In some examples, activation occurs when temperatures exceed 200 degrees Celsius.

The covering sections 66 can, in some examples, eliminate the need for a separate intermediate cover assembly that covers the cells 50. In this example, a bead of adhesive 90 is used to bond the covering sections 66 to the enclosure cover 38. To facilitate the adhesive bond to the thermal barrier 54, a mesh material 94 is embedded within the covering sections 66. The adhesive 90 can fill pores or openings in the mesh material 94 and then cure. The mesh material 94 is a steel mesh in this example.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
first and second thermal barriers each having a divider section and a covering section; and
one or more battery cells sandwiched between the divider section of the first thermal barrier and the divider section of the second thermal barrier along a cell stack axis, the covering section of the first thermal barrier extending axially over at least a portion of the one or more battery cells and interfacing with the covering section of the second thermal barrier, the covering section of the first thermal barrier at least partially axially overlapped with the covering section of the second thermal barrier along the cell stack axis.

2. The traction battery pack assembly of claim 1, wherein the covering section of the first thermal barrier overlaps with the second thermal barrier through a shiplap interface.

3. The traction battery pack assembly of claim 1, wherein the covering section of the first thermal barrier overlaps with the second thermal barrier through a tongue and groove interface.

4. The traction battery pack assembly of claim 1, wherein the covering section of the first thermal barrier includes a lip that extends beneath the covering section of the second thermal barrier.

5. The traction battery pack assembly of claim 1, wherein the covering section of the first thermal barrier includes a plurality of first covering section teeth that extend into respective recesses provided by the covering section of the second thermal barrier, wherein the covering section of the second thermal barrier includes a plurality of second covering section teeth that extend into respective recesses provided by the covering section of the first thermal barrier.

6. The traction battery pack assembly of claim 5, wherein the plurality of first covering section teeth are vertically aligned with the plurality of second covering section teeth.

7. The traction battery pack assembly of claim 5, wherein the covering section of the first thermal barrier includes a lip that extends beneath the covering section of the second thermal barrier.

8. The traction battery pack assembly of claim 7, wherein the lip comprises a mica material.

9. The traction battery pack assembly of claim 8, wherein the mica material is insert molded.

10. The traction battery pack assembly of claim 1, wherein the first thermal barrier and the second thermal barrier each have a T-shaped cross-sectional profile.

11. The traction battery pack assembly of claim 1, further comprising a mesh material at least partially embedded within the covering section of the first thermal barrier.

12. The traction battery pack assembly of claim 11, further comprising adhesively bonding the first thermal barrier to an enclosure of a traction battery pack with an adhesive contacting the mesh material.

13. The traction battery pack assembly of claim 1, wherein the first thermal barrier is a multi-layered, polymer-based structure.

14. The traction battery pack assembly of claim 1, wherein an interface between the covering section of the first thermal barrier and the second thermal barrier is a non-linear interface.

15. The traction battery pack assembly of claim 1, wherein a gap between the covering section of the first thermal barrier and the covering section of the second thermal barrier is configured to communicate vent byproducts.

16. A traction battery pack assembly, comprising:
first and second thermal barriers each having a T-shaped cross-section with a stem section and a T-top section; and
one or more battery cells sandwiched between the stem section of the first thermal battery and the stem section of the second thermal barrier along a cell stack axis, the T-top section of the first thermal barrier extending axially over at least a portion of the one or more battery cells in a first axial direction, the T-top section of the second thermal barrier extending axially over at least a portion of the one or more battery cells in a second axial direction and interfacing with the T-top section of the first thermal barrier along a non-linear interface.

17. The traction battery assembly of claim 16, wherein the non-linear interface is vertically non-linear and horizontally non-linear.

18. The traction battery assembly of claim 16, wherein the T-top section of the first thermal barrier horizontally overlaps the T-top section of the second thermal barrier, wherein the T-top section of the first thermal barrier vertically overlaps the T-top section of the second thermal barrier.

19. The traction battery assembly of claim 16, wherein a gap at the non-linear interface is configured to communicate vent byproducts emitted from the one or more battery cells.
